(19) United States
(12) Patent Application Publication
(10) Pub. No.: US 2012/0253929 A1
(43) Pub. Date: Oct. 4, 2012

(54) ENHANCED ROUTE PLANNING METHOD AND DEVICE

(75) Inventor: William P. Alberth, Prairie Grove, IL (US)

(73) Assignee: MOTOROLA MOBILITY, INC., Libertyville, IL (US)

(21) Appl. No.: 13/076,673

(22) Filed: Mar. 31, 2011

(51) Int. Cl. G06Q 30/00; G01C 21/34

(52) U.S. Cl. 705/14.53; 705/14.69; 705/14.64; 705/14.58; 705/14.67

(57) ABSTRACT

A wireless communication device (200) and method (300). The method (300) can include: providing (310) advertizing content including prioritized locations of advertizing entities; requesting (320) directions to a destination from a navigation application; and generating (330) a primary route to the requested destination and a secondary route to the requested destination, the secondary route adding less than a threshold percentage of additional time or distance to the primary route, the secondary route includes the prioritized locations. Advantageously, the method (300) allows a user to travel a secondary route with minimal additional time, in order to patronize an establishment or run an errand, provides for a more intelligent travel experience and provides cost and time efficient and effective shopping and commuting.

### BACKGROUND

1. Field

The present disclosure relates to an enhanced route planning method and device.

2. Introduction

Users enjoy smart devices in the hope of being more productive and efficient. Retrieving information wirelessly from a trusted source has become common place. Disadvantageously, often while viewing internet content, unwanted and irrelevant advertizing is embedded or streamed over such content.

There is a need for an enhanced route planning method and device for intelligent presentation of advertizing content with navigation information, that is focused and relevant to the interests of a user.

There is a further need to provide a personalized experience for intelligent presentation of enhanced route planning in connection with navigation.

There is yet a further need to provide intelligent presentation of enhanced route planning with advertizing content that is user friendly and can use many components already found in many wireless communication devices.

There is yet a further need to provide an enhanced route planning method and device with intelligent presentation of useful information, that provides a secondary route to a user to patronize a preferred advertizing entity or prioritized location.

Thus, a method and device that addresses these issues and problems would be considered an improvement in the art.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment.

FIG. 2 is an exemplary block diagram of a wireless communication device according to one embodiment.

FIG. 3 is an exemplary block diagram of an enhanced route planning method according to one embodiment.

FIG. 4 illustrates a wireless communication device connected to a docking module in a vehicular application, according to one embodiment.

FIG. 5 is an exemplary block diagram of an enhanced route planning method according to one embodiment.

### DETAILED DESCRIPTION

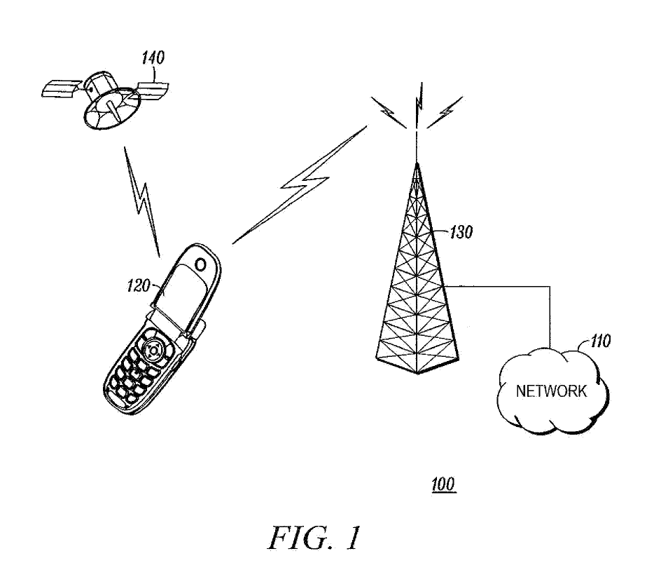

FIG. 1 is an exemplary block diagram of a system 100 according to one embodiment. The system 100 can include a network 110, a terminal 120, and a base station 130. The terminal 120 may be a wireless communication device, such as a wireless telephone, a cellular telephone, a personal digital assistant, a pager, a personal computer, a wireless pad, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can communicate with the network 110 and with other devices on the network 110 by sending and receiving wireless signals via the base station 130, which may also comprise local area, and/or personal area access points. The terminal 120 is shown being in communication with a global positioning system (GPS) 140 satellite, global navigation satellite system (GNSS) or the like, for position sensing and determination.

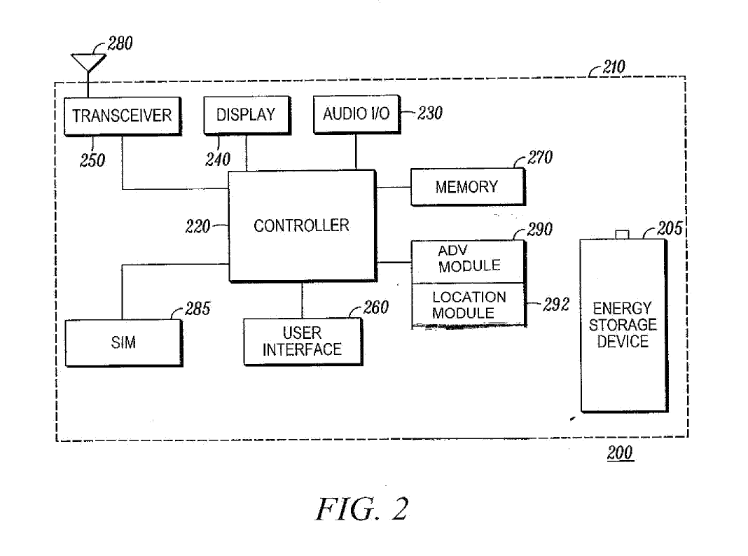

FIG. 2 is an exemplary block diagram of a wireless communication device 200 configured with an energy storage device or module 205, such as in the terminal 120, or in a wireless communication device, for example. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220.

As shown in FIG. 2, the wireless communication device 200 further includes an intelligent advertizing module 290 configured to: advertizing content including prioritized locations of advertizing entities; request directions to a destination from a navigation application; and generate a primary route to the requested destination and a secondary route to the requested destination, the secondary route adding less than a threshold percentage of additional time or distance to the primary route, the secondary route includes the prioritized locations.

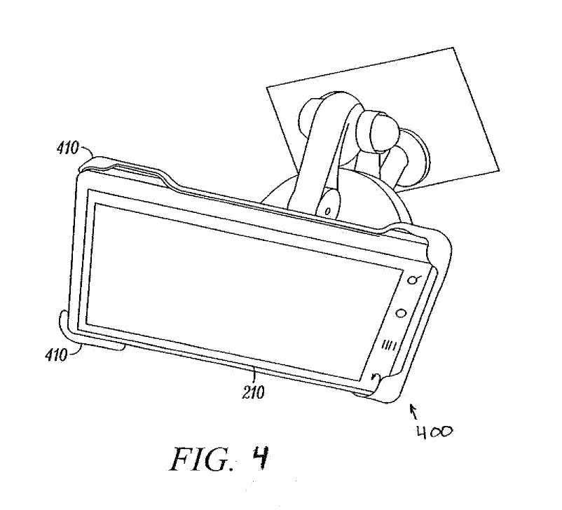

Thus, the advertizing module 290 can include a location module 292, as detailed below. The wireless communication device 200 can be configured to be easily coupled to a docking module configured to receive a portion of the housing 210, as shown in FIG. 4.

In one embodiment, the advertizing module 290 includes the location module 292 capable of being in communication with GPS, GNSS, cellular tower, and alike, coupled to the controller 220. In more detail, the module 290 can reside within the controller 220, can reside within the memory 270, can be an autonomous module, can be software, can be hardware, or can be in any other format useful for a module on a wireless communication device 200.

The display 240 can be a liquid crystal display (LCD), a light emitting diode (LED) display, a touch screen display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory or any other memory that can be coupled to a wireless communication device.

In more detail, the wireless communication device 200 shown in FIG. 2, can include: a housing 210; a controller 220 coupled to the housing 210, the controller 220 configured to control the operations of the wireless communication device, and to provide ancillary computing operations which may be unrelated to wireless communications such as audio or video processing, application processing, etc.

Advantageously, the intelligent advertizing module 290 can automatically and dynamically manage, for example, user settings for specific desired user interface experiences, as detailed herein. It is configured to help present intelligent, timely, relevant and useful advertizing content in connection with navigation and/or route planning, as provided in more detail herein.

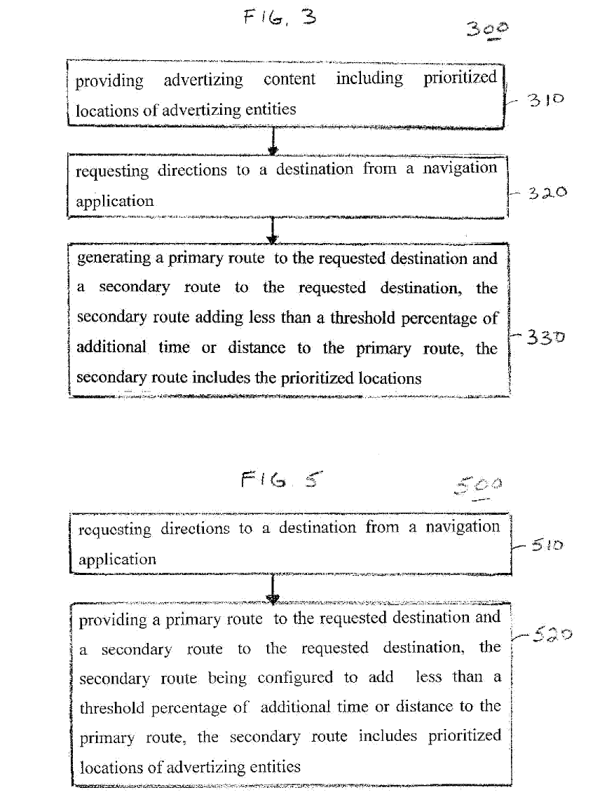

A block diagram of a wireless communication method 300 is shown in FIG. 3. In its simplest form, the method 300 can include: providing 310 advertizing content including prioritized locations of advertizing entities; requesting 320 directions to a destination from a navigation application; and generating 330 a primary route to the requested destination and a secondary route to the requested destination, the secondary route adding less than a threshold percentage of additional time or distance to the primary route, the secondary route includes the prioritized locations.

Advantageously, the method 300 allows a user to travel a secondary route with minimal additional time, in order to patronize a desired establishment, and provides for a more intelligent travel experience and an enhanced route planning for a user to patronize a preferred advertizing entity or prioritized location.

In a preferred embodiment, user profile information can be provided to allow tailored and relevant information, such as advertizing content and prioritized locations of interest to a user. In more detail, the user profile information includes at least one of: a service tier, for example a higher fee could provide better or more in depth information; attributes of a user; and historical information of a user. Beneficially, this information is particularly useful to base the secondary route and prioritized locations on. Further, weighing the attributes can be helpful, to provide an improved secondary route with desired, prioritized locations.

In a preferred embodiment, the advertising content can be based on at least one of fees paid by a user, a predetermined distance in proximity to the route, recommendations, and interests of a user. In one case, a user may pay a higher fee to allow the user to opt out of receiving a lot of ads. And in another case, a user may pay a lower fee and receive more ads, for example. Advertising content can be based on information mined from a social network. For example, if a user's friends have a certain interest, maybe the user does also. If a user expresses a like or dislike on Facebook, Twitter, a Blog or the like, for example, that information can be utilized for improved targeting of more focused and relevant ads. In one case, profile information can be provided from at least one of a web site, club and social network, to weigh and determine advertizing content of interest to a particular user.

In one use case, profile information can include a travel mode, to customize and weigh advertizing content to a user and to provide the secondary route, based on the travel mode. For example, if a user is hiking, riding a bike or driving a car, unique advertizing content can be provided to a user and the secondary route and prioritized locations can be customized, by providing shorter detours when hiking or riding a bike versus driving.

For example, the threshold percentage of additional time or distance to the primary route in one embodiment is about 15% or less in a vehicular use case, which many users will not object to if they are taking a detour to a preferred establishment. The threshold can be adjusted to be less if desired, and this could be done in a user profile. In a biking use case, the threshold percentage is about 10% or less and in hiking it's about 5% or less. As should be understood, the threshold is settable in a network or by a user.

The method 300 can include displaying at least one of the primary route and secondary route with an estimated travel time, to provide timely, useful and logical information for a user.

In one case, the primary route and/or secondary route with or without an estimated travel time can be displayed, considering the time of day and travel mode, for enhanced estimates of travel times during rush hours or off hours. Also, a user can preview the primary and secondary routes, each with advertizing content and entities, prior to or while traveling a route, for enhanced planning and travel. In a preferred use case, navigation directions including the primary and/or the secondary routes can be displayed, and further a primary list of advertising entities in proximity to the primary route and a secondary list of advertising entities in proximity to the secondary route can be displayed, for enhanced planning. When a wireless device with a touch screen is used, a touch screen can be actuated to receive directions and/or information for the actuated advertizing entity touched (like a hot link).

The method 300 can include displaying navigation directions and advertising content concurrently on a display of a wireless communication device, to provide timely, useful and logical information for a user. Stated differently, in a preferred embodiment, the method 300 provides advertizing content including associated locations being prioritized. In the requesting step 320, a user requests navigation directions to a destination. And in the generating step 330, an optimal or primary route to the destination is determined. A secondary route that may be longer then the primary route, but passes by a location or prioritized location associated with an advertisement is also calculated. The secondary route should only be longer then the primary route by a fixed percentage or fixed amount of distance or time. The secondary route is provided to the user including the related advertisement unless the user pays a fee to opt out and receive the primary routes.

In one embodiment, the advertising content can be presented based on whether a recommendation is found for a business establishment or not. Thus, recommended ads can be presented, and if none are found, standard ads from a catalog can be queued or cycled for a certain route.

In more detail, if a recommendation is found, a first page can be displayed listing certain recommended advertising content, and if a recommendation is not found, a second page can be displayed listing certain standard advertising content.

In one case, the provided advertizing content can include at least one of being displayed via streaming, locally cached then displayed, and being presented and displayed at a predetermined periodic rate with the ad timing out after, for example, 3 seconds. As should be understood, other convenient ways are contemplated.

In one use case, a user can select the provided advertizing content and display a location of a business establishment as a way point in proximity to the route. Thus, if the user selects an ad, the business is added as a way point. The user can stop and then continue on his or her journey without having to reprogram navigation.

In a preferred use case, a user can select the provided advertizing content and directions can be provided to the selected business establishment and the location of the selected business establishment can be displayed as a way point in proximity to the route. Providing directions and displaying a way point, would be helpful to a user.

In another embodiment, queuing and displaying the provided advertizing content can be based on at least one of traffic conditions and time of day. For example, in heavy traffic congestion or during rush hour times, a user may desire to patronize and stay near the route, and would desire minimal distance off the route. Likewise, if an establishment is closed, it may not be advisable to advertise when closed.

In another case, a business establishment of the provided advertising content can be highlighted, if a user previously selected or patronized such establishment.

Advantageously, the wireless communication device 200 is configured to help present intelligent, timely, relevant and useful advertizing content in connection with navigation and/or route planning.

In another embodiment, advertizing content can be based on traffic conditions and time of day. For example, in heavy traffic congestion or during rush hour times, a user may desire to patronize and stay near the primary route, and would desire minimal additional distances off the primary route. Likewise, if an establishment is closed, it may not be advisable to advertise when closed.

The method can include being customizable by network personnel or a service provider, or by a user, to provide current accurate advertizing content and a unique user experience.

In another case, the advertising content can be based on fees paid by an advertizing entity, fees paid by a user, a predetermined distance in proximity to a route, recommendations, and interests of a user and historical information, such as if a user previously selected or patronized such establishment. For example, a fee is paid for advertizing content by a business. A user requests a route to a desired destination. The route given to the user may include passing by an establishment associated with the advertisement. The advertisement would be presented to the user when the user passes by the establishment. The route given may be longer then the most optimal route to the destination. The user may gain access to the most optimal route by paying a fee.

In another embodiment, a wireless communication device 200 is disclosed. It can include: a housing 210 including a display; a controller 220 coupled to the housing, the controller 220 configured to control the operations of a wireless communication device; and an intelligent advertizing module 290 configured to: provide prioritized locations of advertizing entities; request directions to a destination from a navigation application; and provide a primary route to the requested destination and a secondary route to the requested destination, the secondary route adding less than a threshold percentage of additional time or distance to the primary route, the secondary route includes the prioritized locations. Advantageously, the wireless communication device 200 is configured to help present intelligent, timely, relevant and useful advertizing content in connection with navigation and/or route planning.

In a preferred embodiment, the wireless communication device 200 can include a location module including at least one of a GPS receiver and global navigation satellite system receiver. The location module 292 can include a GPS receiver or a global navigation satellite system receiver. As should be understood, other location modules can be utilized, such as network location methods, or inertial navigation.

Advantageously, previewing a simulated route and previewing a listing of advertizing content including business establishments, prior to or while traveling along a route, can help a user in planning time effective trips and cost efficient and effective shopping during commutes and trips.

As shown in FIG. 4, a wireless communication device 200 can include a smart phone such as a Motorola Droid, navigation device or Zoom, for example. As should be understood, the wireless communication device 200 can be used with a holster, pouch, belt or arm strap for exercising, hiking, biking and the like.

In FIG. 4, the wireless communication device housing 210 is snap connected to the docking module 400 with fingers 410, to hold a left side securely in the docking module 400, according to one embodiment.

Referring to FIG. 5, a wireless communication method 500 is shown, comprising: requesting 510 directions to a destination from a navigation application, by a user, for example; and providing 520 a primary route to the requested destination and a secondary route to the requested destination, by a server, for example, the secondary route being configured to add less than a threshold percentage of additional time or distance to the primary route, the secondary route includes prioritized locations of advertizing entities. Advantageously, the method allows or instructs a user to travel a secondary route with minimal additional time, in order to patronize a desired establishment or run an errand, provides for a more intelligent travel experience and provides cost and time efficient and effective shopping and commuting.

Also, from an Internet service provider standpoint, the provider can be paid a fee for directing users past an advertiser's location, in the hope of addition customer traffic, and directed advertising, such as coupons, can be presented prior to passing a particular business location, as an incentive to patronize a particular business location in proximity to a route. A user can opt out of being presented with a secondary route, by paying a fee.

In one case, profile information can be provided to determine advertising content of interest to a user, the profile information including at least one of a service tier, attributes and historical information of a user. This feature can help to provide more relevant content to a user

In more detail, profile information can be gotten from a web site, club, social network and the like, to weigh and determine advertising content of interest to a user. This feature can help to provide better directed advertising content to a user.

In one use case, a user can display at least one of the primary route and secondary route with an estimated travel time, considering time of day and travel mode, for improved travel experiences and planning. In addition, a primary list of advertising entities in proximity to the primary route and a secondary list of advertising entities in proximity to the secondary route can be displayed; and a hot link can be provided to be actuated, to receive at least one of directions and information for one of the advertising entities in one of the lists. Users find this feature relevant and useful.

The device 200 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A wireless communication method, comprising:
providing advertizing content including locations of advertizing entities;
requesting directions to a destination from a navigation application; and
generating a primary route to the requested destination and a secondary route to the requested destination, the secondary route adding less than a threshold percentage of additional time or distance to the primary route, the secondary route includes the prioritized locations.

2. The wireless communication method of claim 1, wherein the adverting content is prioritized at least partially by fees paid.

3. The wireless communication method of claim 1, further comprising providing profile information to determine advertizing content of interest to a user.

4. The wireless communication method of claim 1, further comprising providing profile information to determine advertizing content of interest to a user, the profile information including at least one of a service tier, attributes and historical information of a user.

5. The wireless communication method of claim 1, further comprising providing profile information to determine advertizing content of interest to a user, the profile information including at least one of a service tier and attributes of user, to base the secondary route and prioritized locations on.

6. The wireless communication method of claim 1, wherein the secondary route is longer then the primary route by less then a predetermined threshold.

7. The wireless communication method of claim 6, wherein the threshold is a percentage of travel time of the primary route or a percentage of distance of the primary route.

8. The wireless communication method of claim 6, wherein the threshold is dependent on a mode of travel.

9. The wireless communication method of claim 1, further comprising displaying the secondary route only.

10. The wireless communication method of claim 1, further comprising displaying the primary route if the user pays a fee.

11. The wireless communication method of claim 1, further comprising displaying navigation directions and advertising entities concurrently on a display of a wireless communication device.

12. The wireless communication method of claim 1, further comprising displaying navigation directions including at least one of the primary route and the secondary route, and further displaying at least one of a primary list of advertising entities in proximity to the primary route and a secondary list of advertising entities in proximity to the secondary route.

13. The wireless communication method of claim 1, further comprising displaying at least one of a primary list of advertising entities in proximity to the primary route and a secondary list of advertising entities in proximity to the secondary route; and actuating a touch screen to receive at least one of directions and information for the actuated advertizing entity touched.

14. The wireless communication method of claim 1, wherein the advertising content is based on at least one of fees paid by an advertizing entity, fees paid by a user, a predetermined distance in proximity to a route, recommendations, and interests of a user.

15. A wireless communication method, comprising:
requesting directions to a destination from a navigation application; and
providing a primary route to the requested destination and a secondary route to the requested destination, the secondary route being configured to add less than a threshold percentage of additional time or distance to the primary route, the secondary route includes prioritized locations of advertizing entities.

16. The wireless communication method of claim 15, further comprising providing profile information to determine advertizing entities of interest to a user, the profile information including at least one of a service tier, attributes and historical information of a user.

17. The wireless communication method of claim 15, further comprising providing profile information from at least one of a web site, club and social network, to weigh and determine advertizing entities of interest to a user.

18. The wireless communication method of claim 15, further comprising displaying at least one of the primary route and secondary route with an estimated travel time considering time of day and travel mode.

19. The wireless communication method of claim 15, further comprising displaying at least one of a primary list of advertising entities in proximity to the primary route and a secondary list of advertising entities in proximity to the secondary route; and providing a hot link to receive at least one of directions and information for one of the advertizing entities in one of the lists.

20. A wireless communication device, comprising:
a housing including a display;
a controller coupled to the housing, the controller configured to control the operations of a wireless communication device; and
an intelligent advertizing module configured to: provide prioritized locations of advertizing entities; request directions to a destination from a navigation application; and generate a primary route to the requested destination and a secondary route to the requested destination, the secondary route adding less than a threshold percentage of additional time or distance to the primary route, the secondary route includes the prioritized locations.
